(19) United States
(12) Patent Application Publication
(10) Pub. No.: US 2020/0183926 A1
(43) Pub. Date: Jun. 11, 2020

(54) SYSTEM FOR ASSISTING AIRCRAFT FAULT RESOLUTION

(71) Applicant: Airbus SAS, Blagnac (FR)

(72) Inventors: Jean-Marie DAUTELLE, Toulouse (FR); Antoine BOUILLET, Toulouse (FR)

(21) Appl. No.: 16/700,240

(22) Filed: Dec. 2, 2019

(30) Foreign Application Priority Data
Dec. 5, 2018 (FR) 1872386

(51) Int. Cl. G06F 16/2458; G06F 16/248; G06N 5/04; G06K 9/62; B64D 45/00

(52) U.S. Cl. CPC G06F 16/2465; G06F 16/2462; G06F 16/248; B64D 2045/0085; G06K 9/6267; B64D 45/00; G06N 5/04

(57) ABSTRACT

A system for assisting aircraft fault resolution by statistical inference of big data includes secure equipment including a plurality of databases storing big data concerning variables monitored during aircraft monitoring as well as an aggregator module. The system also includes an analyst module, outside the secure equipment, in communication with the aggregator module. The analyst module is used to define a statistical query to be processed by the aggregator module, which performs a statistical inference on the big data stored in the plurality of databases in order to respond to the statistical query. The aggregator module checks that the result of the statistical inference anonymizes the big data in question, and transmits the result of the statistical inference to the analyst module. Thus, the confidentiality of the big data is respected.

### CROSS-REFERENCES TO RELATED APPLICATIONS

This application claims the benefit of the French patent application No. 1872386 filed on Dec. 5, 2018, the entire disclosures of which are incorporated herein by way of reference.

### FIELD OF THE INVENTION

The present invention relates to a system for assisting aircraft fault resolution by statistical inference of big data.

### BACKGROUND OF THE INVENTION

Once aircraft are commissioned, faults and incidents can occur and require investigations to determine their causes and/or conditions of occurrence, whether this be for navigability issues or for matters of improvement in design, manufacture or usage procedure. These investigations are typically carried out by a group of experts, generally from various entities, such as airlines, aircraft design engineering companies, subcontractors and equipment manufacturers.

To enable these investigations to take place, operational data is collected and stored in databases. Given the quantity of aircraft for which such operational data is collected, reference is made to “megadata” (or sometimes “massive data”), and more widely “big data.” This operational data therefore represents a volume of information to be processed which exceeds human intuition and capacities of analysis, and even those of conventional database management computing tools.

In order to be able to improve the effectiveness of aircraft fault resolution and notably because of the fact that incidents are very rare in aviation, it is desirable to be able to perform a statistical inference on big data from various perspectives. Recall that statistical inference involves inferring unknown characteristics of a population from an extract of this population. The characteristics of the extract hence reflect, with a certain probability of error, the characteristics of the population.

The ownership of this big data however poses a major challenge in this approach, since the owners of this big data can refuse direct access to all or part of their content. For example, it can be desirable to perform the statistical inference on the basis of open-access environmental big data (e.g., meteorological big data), paid-access environmental big data (e.g., flight radar big data), big data from aircraft in service (the owner of which is the operating airline), big data from aircraft before commissioning (the owner of which is the aircraft manufacturer), etc.

It is desirable to address this drawback of the prior art. It is thus desirable to provide results of statistical inference upon statistical queries in order to be able to improve the effectiveness of the investigations of experts in the resolution of aircraft faults using a maximum of big data sources, without calling into question any level of desired confidentiality concerning the content of this big data.

### SUMMARY OF THE INVENTION

An object of the present invention is to propose a system for assisting aircraft fault resolution by statistical inference of big data, including a plurality of databases storing big data concerning variables monitored during aircraft monitoring as well as a device implementing an aggregator module tasked with querying the databases in the framework of a statistical inference. The system additionally includes: secure equipment, including the device implementing the aggregator module, as well as the plurality of databases, so as to prevent external access to the big data; and a device implementing an analyst module, outside the secure equipment, in communication with the aggregator module. Furthermore, the analyst module includes: means for defining a statistical query, the statistical query requiring searching for a possible correlation between at least one event relating to a fault and at least one variable among the big data in the plurality of databases; and means for transmitting the statistical query to the aggregator module. Furthermore, the aggregator module includes: means for performing a statistical inference on the big data stored in the plurality of databases in order to respond to the statistical query; means for checking that the result of the statistical inference anonymizes the big data in question; means for transmitting the result of the statistical inference to the analyst module for the case in which the result of the statistical inference anonymizes the big data in question; and means for rejecting the statistical query for the case in which the result of the statistical inference does not anonymize the big data in question. Thus, the effectiveness of the investigations of experts in aircraft fault resolution is improved using a maximum of big data sources, without calling into question any level of desired confidentiality concerning the content of this big data.

According to a particular embodiment, the statistical query includes a context defining a framework for searching the big data in the plurality of databases, the context specifying whether the statistical inference relates to all the aircraft for which big data is present in the plurality of databases or only to a subset, and the aggregator module includes means for limiting the statistical inference to the context.

According to a particular embodiment, the aggregator module includes means for checking that the context is not defined with respect to big data parameters excluded for confidentiality reasons and means for rejecting the statistical query for the case in which the context is defined with respect to big data parameters excluded for confidentiality reasons.

According to a particular embodiment, the aggregator module checks that the plurality of databases contains at least K times more samples in the context than occurrences of each event considered in the statistical query, where K is a non-zero positive integer.

According to a particular embodiment, the analyst module includes means for exporting a graphical user interface providing the following components: “Context” components to define the context; “Event” components to select at least one event to form the statistical query; “Variable” components to select at least one of the variables to form the statistical query; and “Combiner” components to formulate the statistical query from “Context,” “Event” and “Variable” components. The graphical user interface additionally provides the following operators: “Logic” operators to perform combinatorial operations between “Variable” components; “Time” operators to fix timeframes on “Variable” components and on “Event” components; and “Union” operators to merge “Variable” components, combine “Event” components and combine “Context” components; “Filter” operators to filter “Variable” components, filter “Event” components and filter “Context” components.

According to a particular embodiment, the plurality of databases is completed by at least one database storing big data in open access arrangement.

According to a particular embodiment, the aggregator module includes means for storing in at least one dedicated database of the secure equipment private information supplied via the analyst module, and the aggregator module additionally performs the statistical inference by exploiting the private information.

According to a particular embodiment, the aggregator module supplies to the analyst module the result of the statistical inference in the form of a contingency table for each variable targeted by the statistical query.

According to a particular embodiment, the analyst module includes: means for determining, for each contingency table, probability deviation values, with respect to a theoretical distribution of observations of the variable in question; means for determining, for each contingency table, values of test strength; and means for classifying the content of the contingency tables as a function of the probability deviation values and test strength values; the classification indicates whether the content in question shows whether or not the variable considered is correlated with the event or events targeted by the statistical query, or whether the inference result is inconclusive.

According to a particular embodiment, the analyst module includes means for producing a volcano plot visualization of the content of each contingency table.

Another object of the present invention is to propose a method for assisting aircraft fault resolution by statistical inference of big data, the method being implemented by a system including a plurality of databases storing big data concerning variables monitored during aircraft monitoring as well as a device implementing an aggregator module tasked with querying the databases in the framework of a statistical inference. The system additionally includes: secure equipment including the device implementing the aggregator module as well as the plurality of databases so as to prevent external access to the big data; and a device implementing an analyst module, outside the secure equipment, in communication with the aggregator module. Hence, the method includes the following steps implemented by the analyst module: defining a statistical query, the statistical query requiring searching for a possible correlation between at least one event relating to a fault and at least one of the variables among the big data in the plurality of databases; and transmitting the statistical query to the aggregator module. Furthermore, the method includes the following steps implemented by the aggregator module: performing a statistical query on the big data stored in the plurality of databases in order to respond to the statistical query; checking that the result of the statistical inference anonymizes the big data in question; transmitting the result of the statistical inference to the analyst module for the case in which the result of the statistical inference anonymizes the big data in question; and rejecting the statistical query for the case in which the result of the statistical inference does not anonymize the big data in question.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems for detecting skew in a wing slat of an aircraft described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

### BRIEF DESCRIPTION OF THE DRAWINGS

The abovementioned features of invention, as well as others, will become clearer upon reading the following description of at least one example embodiment, the description being made with reference to the appended drawings, in which:

FIG. 1 schematically illustrates a system for assisting aircraft fault resolution according to the present invention;

FIG. 2 schematically illustrates a hardware arrangement of a device of the system for assisting aircraft fault resolution according to a particular embodiment;

FIG. 3 schematically illustrates a statistical query formulated by combining components and operators, in a particular embodiment of the invention;

FIG. 4 schematically illustrates a flow chart of an algorithm for defining and submitting a statistical query implemented by an analyst module of the system for assisting aircraft fault resolution;

FIG. 5 schematically illustrates a flow chart of an algorithm for processing a statistical query implemented by an aggregator module of the system for assisting aircraft fault resolution; and

FIG. 6 schematically illustrates a flow chart of an algorithm for processing contingency tables implemented by the analyst module of the system for assisting aircraft fault resolution, in a particular embodiment of the present invention.

### DETAILED DESCRIPTION OF THE PREFERRED EMBODIMENTS

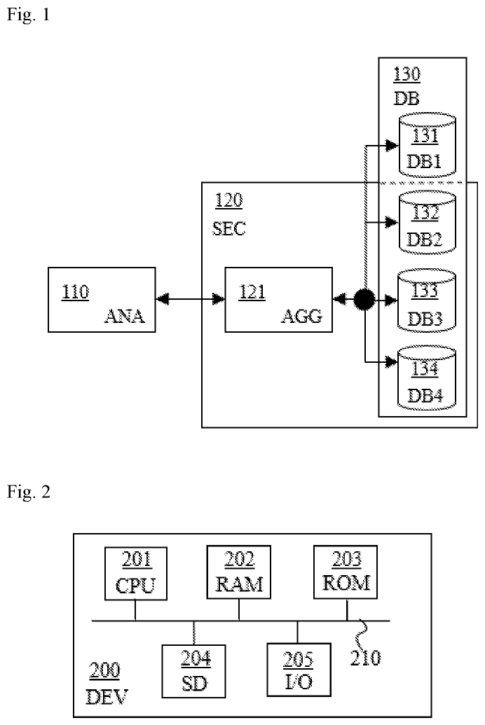

FIG. 1 schematically illustrates a system for assisting aircraft fault resolution according to the present invention.

The system for assisting aircraft fault resolution includes a first device implementing an analyst module ANA 110.

The system for assisting aircraft fault resolution includes a second device implementing an aggregator module AGG 121. The second device is part of secure equipment SEC 120.

For example, the first device is a PC (Personal Computer) and the second device is a supercomputer.

The aggregator module AGG 121 accesses a plurality of databases DB 130. At least one of these databases contains big data concerning variables monitored during aircraft monitoring, and more particularly relating to incidents that have arisen on these aircraft, and for which the contents must not be, and are not, displayed outside the environment of the secure equipment SEC 120. The secure equipment SEC 120 prevents any external access to the big data. In FIG. 1, the databases DB2 132, DB3 133, DB4 134 thus contain big data with restricted access limited to the secure equipment SEC 120. Note that the analyst module ANA 110 is outside the secure equipment SEC 120.

One or more databases DB1 131, containing big data for which the contents are set up as open access, can enrich the plurality of databases DB 130. For example, the database DB1 131 contains meteorological big data indicating what the meteorological conditions were at such or such place at such or such moment.

The first device implementing the analyst module ANA 110 and the second device implementing the aggregator module AGG 121 are connected by a communication line. Since the information of confidential nature in the plurality of databases DB 130 does not leave the environment of the secure equipment SEC 120, this communication line does not need to be secure. The aggregator module AGG 121 and the databases DB2 132, DB3 133 and DB4 134 can be connected by secure tunnels, thereby providing for distributing the secure equipment SEC 120 over several sites.

The analyst module ANA 110 provides an input interface for defining a statistical query. The statistical query requires searching among the big data in the plurality of databases DB 130 for a possible correlation between at least one event relating to a fault and at least one variable monitored as part of aircraft monitoring. The statistical query preferably includes a context defining a framework for searching the big data in the plurality of databases DB 130, the context specifying whether the statistical inference relates to all the aircraft for which big data is present in the plurality of databases DB 130 or only to a subset.

According to an example, this input interface is a file in which the statistical query is formulated. Preferably, the first device is equipped with a screen and a control interface, such as a mouse-keyboard set. Thus, a human operator can formulate the statistical query by combining various components and operators, using as input interface a graphical user interface GUI exported by the analyst module ANA 110. Thus, the GUI of the analyst module ANA 110 provides the following components:

1. Context

2. Event

3. Variable

4. Combiner

The “Context” components provide for defining an aircraft context to be considered in the plurality of databases DB 130, for example: all the aircraft, climbing aircraft, specific aircraft models, etc.

The “Event” components provide for selecting events to be found in the plurality of databases DB 130, for example: time-stamped list of occurrences, particular fault for example identified by a specific code, etc.

The “Variable” components provide for selecting parameters to evaluate by statistical inference with respect to one or more defined events, for example: age of the aircraft or of a particular part, data of a particular sensor, rough landing, vibrations, etc. Each parameter is associated with at least one condition with respect to a value or a field of values to define a status that can be expressed at any moment from parameters of any population sample of the context considered by “true,” “false” or “unknown.” According to an example, a low altitude variable LOW_ALTITUDE relates to the altitude parameter associated with the condition “<1000 feet” (approximately 300 meters), a middle altitude variable MIDDLE_ALTITUDE relates to the altitude parameter associated with the condition “≥1000 feet” (approximately 300 meters) and “<25000 feet” (7620 meters), and a high altitude variable HIGH_ALTITUDE relates to the altitude parameter associated with the condition “≥25000 feet” (7620 meters). According to another example, a young age variable YOUNG relates to the age parameter associated with the condition “<730 days,” a middle age variable MIDDLE_AGE relates to the age parameter associated with the condition “≥730 days” and “<4380 days,” and an old age variable OLD relates to the age parameter associated with the condition “≥4380 days.”

Variables of the same type (age, altitude, etc.) can be grouped together in the same “Variable” components. For example, the variables YOUNG, MIDDLE_AGE and OLD can be grouped together in the same component, in order to easily define a statistical query which relates to a statistical inference simultaneously covering these three age brackets considered.

The “Combiner” components provide for assembling the “Event” components and the “Variable” components in a big data population defined by the “Context” components in order to formulate a statistical query, typically: “Is there a correlation between VARIABLES and EVENTS considering the defined CONTEXT?”

In addition to the above components, the GUI of the analyst module ANA 110 preferably provides operators, which enable the statistical query to be made more complex and therefore refined:

1. Logic (logic AND, logic OR, EXCLUSIVE OR, etc.)

2. Time (minimum duration, lag, etc.)

3. Union

4. Filter

The “Logic” operators provide for performing a combinatorial operation between “Variable” components.

The “Time” operators provide for fixing a timeframe to an “Event” component or a “Variable” component.

The “Union” operators provide for merging “Context” components, merging “Event” components and merging “Variable” components.

The “Filter” operators provide for filtering “Context” components, filtering “Event” components and filtering “Variable” components.

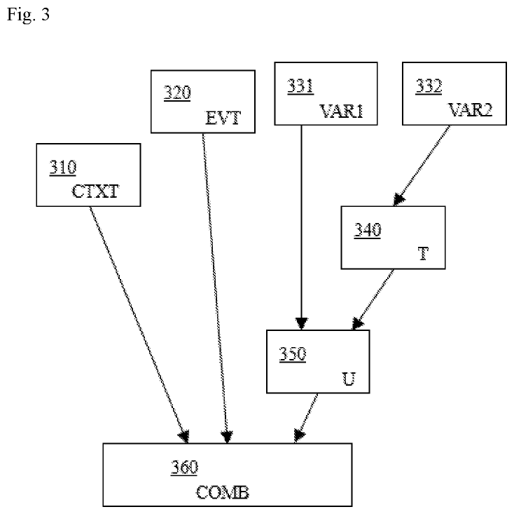

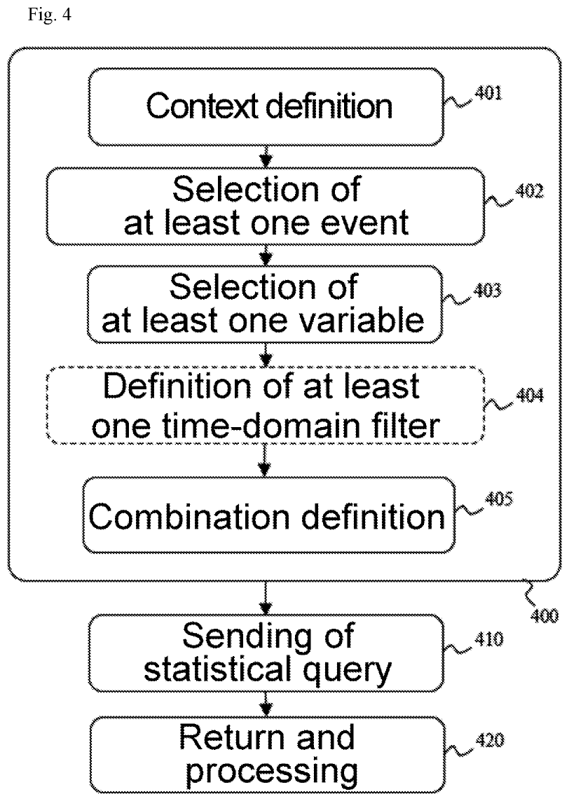

An example is schematically illustrated in FIG. 3. A “Context” component, indicated as CTXT 310, is defined therein. For example, the component CTXT 310 limits the statistical inference context to a particular type of aircraft, for example aircraft of the Airbus A350 family.

An “Event” component, indicated as EVT 320, is defined therein. A certain type of event is thus selected, representative of a particular fault. For example, the component EVT 320 identifies an EDP (Engine Driven Pump) fault.

A “Variable” component, indicated as VAR1 331, is defined therein. A first parameter is thus selected to be evaluated by statistical inference with respect to the event described in the component EVT 320. For example, this first parameter concerns age. Another “Variable” component, indicated as VAR2 332, is defined therein. A second parameter is thus selected to be evaluated by statistical inference with respect to the event described in the component EVT 320. For example, this second parameter concerns altitude.

A “Union” operator, indicated as U 350, is defined therein. The operator U 350 is applied to the component VAR2 332 after application of the operator T 340 and to the component VAR1 331. The age and altitude parameters are then simultaneously evaluated by statistical inference.

A “Combiner” component, indicated as COMB 360, is defined therein. The component COMB 360 defines the statistical query: “Is there a correlation between VAR1 or VAR2 and EVT considering the context CTXT?” This example provides for attempting to determine whether the EDP faults are statistically linked to the age of the EDP and/or to atmospheric pressure matters.

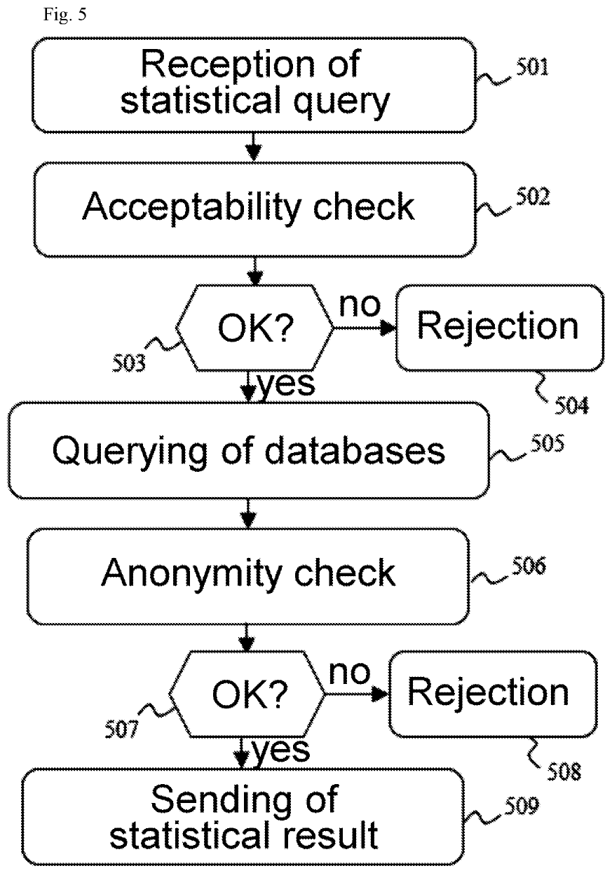

Once formulated, the statistical query is transmitted by the analyst module ANA 110 to the aggregator module AGG 121. The aggregator module AGG 121 then processes the statistical query by analyzing the big data stored in the plurality of databases DB 130. This aspect is detailed hereafter with reference to FIG. 5.

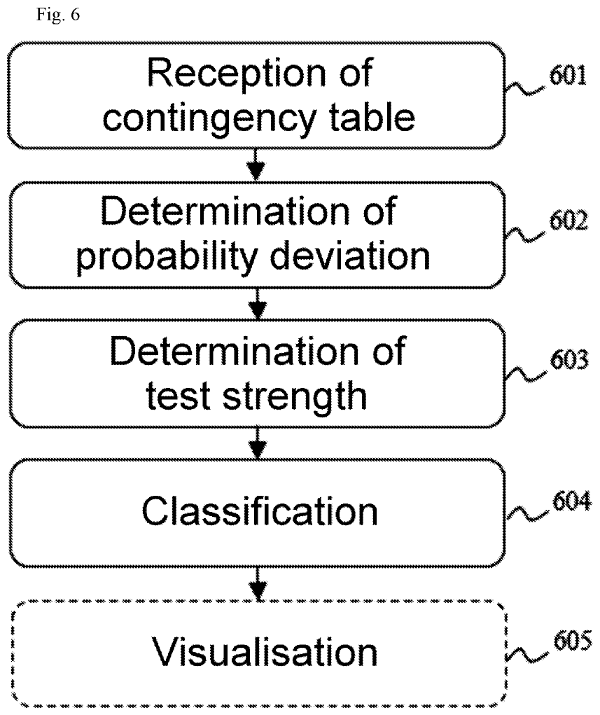

The analyst module ANA 110 provides an output interface for providing the response to the statistical query posed. According to an example, this output interface is a file. Preferably, the GUI of the analyst module ANA 110 provides the response to the statistical query posed, for example in the form of a volcano plot visualization. This provides for more easily and rapidly identifying the variables of interest, particularly when the statistical query relates to a combination of a multitude of variables. This aspect is detailed hereafter with reference to FIG. 6.

In a particular embodiment, one or more dedicated databases of the plurality of databases DB 130 serve to enrich the context of the statistical query with private information. This enriching can be carried out by the analyst module ANA 110, through which the private data is supplied to the aggregator module AGG 121 which is then tasked with storing the private data in a dedicated database. The dedicated database or databases are included in the secure equipment SEC 120 and can then be accessed only as part of a statistical inference, in order to respect their confidentiality. For example, assume an expert wishes to study the impact of solar radiation on aircraft equipment for which faults have been picked up. The expert has a model for calculating the solar flux as a function of time and geographic position, but the expert does not have direct access to a sufficient amount of position data for aircraft that have endured this fault. The expert can then import the model as private data and thus enrich the big data with the solar flux parameter. The expert still does not have direct access to the resulting big data, but statistical queries can then be posed on a possible correlation between the effect of the solar flux and/or several events relating to the faults picked up.

FIG. 2 schematically illustrates a hardware arrangement of a device DEV 200 of the system for assisting aircraft fault resolution. The first device implementing the analyst module ANA 110 and/or the second device implementing the aggregator module AGG 121 can be constructed according to this hardware arrangement.

The device DEV 200 includes, connected by a communication bus 210: a processor 201; random-access memory 202; read-only memory (ROM) 203, or EEPROM (Electrically-Erasable Programmable Read Only Memory); a storage unit 204, such as a hard disk drive HDD, or a storage medium reader, such as an SD (Secure Digital) card reader; and an input-output interface manager 205.

For the first device implementing the analyst module ANA 110, the input-output interface manager 205 provides for communicating with the second device implementing the aggregator module AGG 121. Preferably, the input-output interface manager 205 provides for interacting with a human operator, as already described.

For the second device implementing the aggregator module AGG 121, the input-output interface manager 205 provides for communicating with the first device implementing the analyst module ANA 110, as well as with the plurality of databases DB 130.

The processor 201 is capable of executing instructions loaded into the random-access memory 202 from the read-only memory 203, from an external memory, from a storage medium (such as an SD card) or from a communication network. When the device DEV 200 is powered up, the processor 201 is capable of reading instructions from the random-access memory 202 and executing them. These instructions form a computer program bringing about the implementation, by the processor 201, of all or part of the algorithm and steps described hereafter.

All or part of the algorithms and steps described hereafter can thus be implemented in software form by the execution of a set of instructions by a programmable machine, for example a DSP (Digital Signal Processor) processor or a microcontroller, or be implemented in hardware form by a dedicated component or machine, for example an FPGA or ASIC component. Generally, the device DEV 200 includes electronic circuitry adapted and configured to implement, in software and/or hardware form, the algorithms and steps described hereafter in relation to the device DEV 200 in question.

FIG. 4 schematically illustrates a flow chart of an algorithm for defining and submitting a statistical query implemented by the analyst module ANA 110.

In a step 400, the analyst module ANA 110 defines a statistical query.

Step 400 can be detailed by a set of steps 401 to 405.

In step 401, the analyst module ANA 110 acquires a context definition, preferably via a “Context” component or several “Context” components connected by an operator.

In step 402, the analyst module ANA 110 acquires a selection of at least one event, preferably via an “Event” component or several “Event” components connected by an operator. When several events are thus selected, these events are typically suspected of having the same triggering cause.

A list of events available to the analyst module ANA 110 can depend on the context defined at step 401, i.e., the context must not have samples of big data for which no information concerning this event has been listed. For example, if the events have been recorded only for one model of aircraft, the context should contain big data samples only for this model of aircraft. In a particular embodiment, once the context is defined, the analyst module ANA 110 queries the aggregator module AGG 121 to determine which events have been logged for the defined context, the aggregator module AGG 121 searching (or having searched) the plurality of databases DB 130 in order to do this.

In step 403, the analyst module ANA 110 acquires a selection of at least one variable, preferably via a “Variable” component or several “Variable” components connected by one or more “Logic” or “Union” or “Filter” operators.

In step 404, the analyst module ANA 110 can acquire a timeframe definition on one or more variables and/or one or more events, preferably via one or more “Time” operators.

In step 405, the analyst module ANA 110 acquires a definition for combining the context (step 401), the event or events (step 402), the variable or variables (step 403), and possibly the timeframe (step 404), in order to formulate the statistical query.

Step 400 is followed by a step 410 in which the analyst module ANA 110 transmits to the aggregator module AGG 121 the statistical query formulated at step 400. The method applied by the aggregator module AGG 121 is detailed hereafter with reference to FIG. 5. Then, the analyst module ANA 110 is placed in standby awaiting a return from the aggregator module AGG 121.

Then, in a step 420, the analyst module ANA 110 obtains the return from the aggregator module AGG 121 concerning the statistical query transmitted at step 410. As detailed hereafter, the aggregator module AGG 121 may have formulated a rejection or have returned a statistical result. The analyst module ANA 110 then carries out the appropriate processing (visualization, saving in a file, etc.). A particular embodiment is detailed hereafter with reference to FIG. 5.

FIG. 5 schematically illustrates a flow chart of an algorithm for processing a statistical query implemented by the aggregator module AGG 121.

In a step 501, the aggregator module AGG 121 receives the statistical query transmitted by the analyst module ANA 110 at step 410.

In a step 502, the aggregator module AGG 121 checks the acceptability of the statistical query. The aggregator module AGG 121, in particular, checks that the context is not defined with respect to big data parameters excluded for confidentiality reasons. For example, contexts limited to particular aircraft (identified by their manufacturer serial number MSN) or of a particular airline can be prohibited. According to another example, the aggregator module AGG 121 checks that the plurality of databases DB 130 contains many more samples in the defined context than occurrences of each event considered in the statistical query. In other words, the aggregator module AGG 121 checks that the plurality of databases DB 130 contains at least K times more samples in the defined context than occurrences of each event considered in the statistical query, where K is a non-zero positive integer, for example equal to 100 or 1000. According to yet another example, the aggregator module AGG 121 checks that the big data population concerned for the context of the statistical query is sufficient to provide for ensuring that the result of the statistical inference does not prejudice the confidentiality of the big data, i.e., the big data population thus concerned is greater than a predefined threshold.

In a step 503, the aggregator module AGG 121 determines whether the acceptability check for the statistical query is positive. If that is the case, a step 505 is carried out; otherwise, the aggregator module AGG 121 rejects the statistical query from the analyst module ANA 110 in a step 504 and the algorithm is ended.

In a step 505, the aggregator module AGG 121 queries the plurality of databases DB 130 to respond to the statistical query. The resulting processing time increases linearly with the quantity of samples considered in the population of the context defined in the statistical query. The aggregator module AGG 121 performs a statistical inference to respond to the statistical query.

The theoretical distribution of an event in a population is equivalent to that of a thrown die, where the result of the throw of the die is the occurrence of the event (“true,” “false” or “unknown”). By knowing the proportion of “true,” “false” or “unknown” in the population considered, binomial tests can be performed. A binomial test is an exact test of the statistical significance of deviations from a theoretical distribution of observations.

Given that the occurrence time interval or the uncertainty of the instant of the occurrence of an event can cover several samples, each sample has a weight of 1/n with respect to this event, where n is the quantity of samples covered by the event in question. This approach advantageously provides for producing an average count in a contingency table computation (floating values). Recall that contingency tables are matrices, potentially multi-variable, which show the frequency distribution of the variable or variables considered. The aggregator module AGG 121 then performs the following aggregations on the context samples for each variable of the statistical query:
Quantity of “true;” and
Quantity of “false.”

Furthermore, the aggregator module AGG 121 performs the following aggregations on the samples appearing during the occurrence of each event:
Sum of the weights of the samples with the variable at “true;” and
Sum of the weights of the samples with the variable at “false.”

In a step 506, the aggregator module AGG 121 checks that the result of the statistical inference performed at step 505 anonymizes the big data concerned, i.e. it is not possible to deduce therefrom for example which airline the big data that has been used to obtain this result is from. In a particular embodiment, the aggregator module AGG 121 anonymizes the result. For example, generic pseudonyms can be used to mask the origin of the big data. An airline name can thus be replaced by the term AIRLINE followed by a random number assigned by the aggregator module AGG 121. However, this approach can be used only when the quantities of samples for airlines are similar in the defined context, to avoid being able to trace back the name of the airline in question by relying on the quantity of samples.

In a step 507, the aggregator module AGG 121 determines whether the check that the result of the statistical inference anonymizes the big data concerned (or whether the big data has been anonymized) is positive. If that is the case, a step 509 is carried out; otherwise, the aggregator module AGG 121 rejects the statistical query from the analyst module ANA 110 in a step 508 and the algorithm is ended.

In step 509, the aggregator module AGG 121 sends to the analyst module ANA 110 the result of the statistical inference, i.e. the response to the statistical query. Preferably, the result of the statistical inference takes the form of a contingency table for each variable targeted by the statistical query.

FIG. 6 schematically illustrates a flow chart of an algorithm for processing contingency tables implemented by the analyst module ANA 110, in a particular embodiment of the present invention.

In a step 601, the analyst module ANA 110 receives the result of the statistical inference performed by the aggregator module AGG 121 in the form of a contingency table for each variable indicated in the statistical query previously formulated by the analyst module ANA 110 (see FIG. 4).

In a step 602, the analyst module ANA 110 determines, for each contingency table, probability deviation values, called p-values, with respect to a theoretical distribution of observations of the variable concerned.

In a step 603, the analyst module ANA 110 determines, for each contingency table, values of test strength.

In a step 604, the analyst module ANA 110 classifies the content of the contingency tables as a function of the probability deviation values and test strength values. The classification indicates whether the content in question shows whether or not the variable considered is correlated with the event or events targeted by the statistical query, or whether the inference result is inconclusive. When the probability deviation values are lower than a predefined threshold TH1, for example 5%, the variable in question and the event or events considered in the statistical query previously formulated by the analyst module ANA 110 (see FIG. 4) are considered to be correlated. If the test strength values are higher than a predefined threshold TH2, for example 80%, the variable in question and the event or events considered in the statistical query previously formulated by the analyst module ANA 110 (see FIG. 4) are considered to be decorrelated. In other cases, the result is considered to be inconclusive through a lack of information in the plurality of databases DB 130.

In a step 605, the analyst module ANA 110 can perform a volcano plot visualization. A volcano plot is a type of scatter diagram which plots statistical significance (as ordinates, Y-axis) as a function of the statistical effect called “fold change” (as abscissas, X-axis). On the volcanic plot, the ordinates (Y-axis) typically represent the opposite of log₁₀ of the p-values and the abscissas (X-axis) log₂ of the statistical effect.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for assisting aircraft fault resolution by statistical inference of big data, comprising:
a plurality of databases storing big data concerning variables monitored during aircraft monitoring,
a device implementing an aggregator module tasked with querying the databases in a framework of a statistical inference,
secure equipment including the device implementing the aggregator module, as well as the plurality of databases, to prevent external access to the big data; and
a device implementing an analyst module, outside the secure equipment, in communication with the aggregator module;
wherein the analyst module comprises:
means for defining a statistical query, the statistical query requiring searching for a possible correlation between at least one event relating to a fault and at least one of the variables among the big data in the plurality of databases; and
means for transmitting the statistical query to the aggregator module; and
wherein the aggregator module comprises:
means for performing a statistical inference on the big data stored in the plurality of databases in order to respond to the statistical query;
means for checking that a result of the statistical inference anonymizes the big data in question;
means for transmitting the result of the statistical inference to the analyst module for a case in which the result of the statistical inference anonymizes the big data in question; and
means for rejecting the statistical query for the case in which the result of the statistical inference does not anonymize the big data in question.

2. The system according to claim 1, whreein the statistical query comprises a context defining a framework for searching the big data in the plurality of databases, the context specifying whether the statistical inference relates to all the aircraft for which big data is present in the plurality of databases or only to a subset, and the aggregator module comprises means for limiting the statistical inference to the context.

3. The system according to claim 2, wherein the aggregator module comprises:
means for checking that the context is not defined with respect to big data parameters excluded for confidentiality reasons, and
means for rejecting the statistical query for a case in which the context is defined with respect to big data parameters excluded for confidentiality reasons.

4. The system according to claim 2, wherein the aggregator module checks that the plurality of databases contains at least K times more samples in the context than occurrences of each event considered in the statistical query, where K is a non-zero positive integer.

5. The system according to claim 2,
wherein the analyst module comprises means for exporting a graphical user interface providing the following components:
“Context” components to define the context;
“Event” components to select at least one event to form the statistical query;
“Variable” components to select at least one so-called variable to form the statistical query; and
“Combiner” components to formulate the statistical query from “Context,” “Event” and “Variable” components,
wherein the graphical user interface additionally provides the following operators:
“Logic” operators to perform combinatorial operations between “Variable” components;
“Time” operators to fix timeframes on “Variable” components and on “Event” components;
“Union” operators to merge “Variable” components, combine “Event” components and combine “Context” components; and
“Filter” operators to filter “Variable” components, filter “Event” components and filter “Context” components.

6. The system according to claim 1, wherein the plurality of databases is completed by at least one database storing big data in open access arrangement.

7. The system according to claim 1, wherein the aggregator module comprises means for storing in at least one dedicated database of the secure equipment private information supplied via the analyst module, and wherein the aggregator module additionally performs the statistical inference by exploiting the private information.

8. The system according to claim 1, wherein the aggregator module supplies to the analyst module a result of the statistical inference formed as a contingency table for each variable targeted by the statistical query.

9. The system according to claim 8, wherein the analyst module comprises:
means for determining, for each contingency table, probability deviation values, with respect to a theoretical distribution of observations of the variable in question;
means for determining, for each contingency table, values of test strength;
means for classifying a content of the contingency tables as a function of the probability deviation values and test strength values;
a classification indicating whether the content in question shows whether or not the variable considered is correlated with the event or events targeted by the statistical query, or whether an inference result is inconclusive.

10. The system according to claim 8, wherein the analyst module comprises means for producing a volcano plot visualization of a content of each contingency table.

11. A method for assisting aircraft fault resolution by statistical inference of big data, the method being implemented by a system comprising:
a plurality of databases storing big data concerning variables monitored during aircraft monitoring;
a device implementing an aggregator module tasked with querying the databases in a framework of a statistical inference;
secure equipment including the device implementing the aggregator module as well as the plurality of databases so as to prevent external access to the big data; and
a device implementing an analyst module, outside the secure equipment, in communication with the aggregator module;
the method comprising the following steps implemented by the analyst module:
defining a statistical query, the statistical query requiring searching for a possible correlation between at least one event relating to a fault and at least one of the variables among the big data in the plurality of databases; and
transmitting the statistical query to the aggregator module;
wherein the method comprises the following steps implemented by the aggregator module:
performing a statistical inference on the big data stored in the plurality of databases in order to respond to the statistical query;
checking that a result of the statistical inference anonymizes the big data in question;
transmitting the result of the statistical inference to the analyst module for the case in which the result of the statistical inference anonymizes the big data in question; and
rejecting the statistical query for a case in which the result of the statistical inference does not anonymize the big data in question.
